(19) United States
(12) Patent Application Publication
(10) Pub. No.: US 2008/0070651 A1
(43) Pub. Date: Mar. 20, 2008

(54) Headset Slider Mechanism

(75) Inventors: Keng Hwee Ong, Singapore (SG); Jeong J. Ma, Long Grove, IL (US)

Correspondence Address: MOTOROLA INC, 600 NORTH US HIGHWAY 45, W4 - 39Q, LIBERTYVILLE, IL, 60048-5343, US

(73) Assignee: MOTOROLA, INC., LIBERTYVILLE, IL (US)

(21) Appl. No.: 11/782,632

(22) Filed: Jul. 24, 2007

Related U.S. Application Data
(60) Provisional application No. 60/820,176, filed on Jul. 24, 2006.

(51) Int. Cl. H04M 1/02

(52) U.S. Cl. 455/575.4

(57) ABSTRACT

A small portable headset includes a housing (102) including a first housing member (104) and a second housing member (106), said first housing member slidingly carried on said second housing member. A spring (402) carried in said housing is biased to push said second housing member away from said first housing member to move said housing to an open position. A damper (404) carried in said housing to resist movement of the second housing away from said first housing member. A key assembly carried in said housing includes a key (150), said key actuated to release said first and second housing members to slide apart responsive to the force of said spring. Said key assembly includes an electrical switch (332) positioned below said key and actuated by pressing the key when said housing is in an open position, and an electrical circuit (1500) responsive to actuation of said switch when the housing is in the open position to transmit a mode change signal.

### FIELD OF THE DISCLOSURE

The present disclosure relates generally to headsets, and more particularly to a headset including a slider mechanism.

### BACKGROUND

A variety of different portable headset designs are available which enable hands-free operation of a communication device. These headsets include a microphone, a speaker, an electrical circuit for routing and/or processing electrical signals, and a battery supplying power. In use, the smallest headsets are positioned in or hang on a user's ear.

Challenges faced by those developing small portable headsets include making them esthetically appealing, light enough to hang over an ear, large enough to house the components and provide acoustic isolation between the microphone and speaker, and small enough for comfortable use and portable storage when not in use. Various designs have been created, but designers continue to seek improved performance in a compelling consumer design.

The various aspects, features and advantages of the disclosure will become more fully apparent to those having ordinary skill in the art upon careful consideration of the following Detailed Description thereof with the accompanying drawings described below. The drawings may have been simplified for clarity and are not necessarily drawn to scale.

### BRIEF DESCRIPTION OF THE DRAWINGS

The present invention will hereinafter be described in conjunction with the following drawing figures, wherein like numerals denote like elements, and

FIG. 1 illustrates a headset in a closed position.

FIG. 2 illustrates the headset according to FIG. 1 in an open position.

FIG. 3 illustrates an exploded view of the headset according to FIG. 1.

FIG. 4 illustrates an enlarged view of the spring and damper mechanism for the headset according to FIG. 1.

FIG. 5 illustrates a perspective view of a portion of headset according to FIG. 1 in the closed position with the one side wall, the circuit board, and top housing section removed.

FIG. 6 illustrates a perspective view of an enlarged portion of the headset according to FIG. 1 in the closed position with the one side wall, the circuit board, and top housing section removed.

FIG. 7 illustrates a side cross sectional view of the headset according to FIG. 1 in the closed position with the one side removed.

FIG. 8 illustrates a perspective view of a portion of headset according to FIG. 1 in the open position with the one side wall, the circuit board, and top housing section removed.

FIG. 9 illustrates a perspective view of an enlarged portion of the headset according to FIG. 1 in the open position with the one side wall, the circuit board, and top housing section removed.

FIG. 10 illustrates a side cross sectional view of the headset according to FIG. 1 in the open position with the one side removed.

FIG. 11 illustrates a top view of the headset according to FIG. 1 in the closed position.

FIG. 12 illustrates a perspective view of an enlarged portion of the headset according to FIG. 1 cut vertically through the key.

FIG. 13 illustrates a perspective view of an enlarged portion of the headset according to FIG. 1 in the open position with the one side wall, the circuit board, and top housing section removed.

FIG. 14 illustrates a perspective view of an enlarged portion of the headset according to FIG. 1 in the open position with the one side wall, the circuit board, and top housing section removed.

FIG. 15 illustrates the headset, device and base in block diagram form.

FIG. 16 is a flow chart illustrating operation of the headset according to FIG. 15.

### DETAILED DESCRIPTION

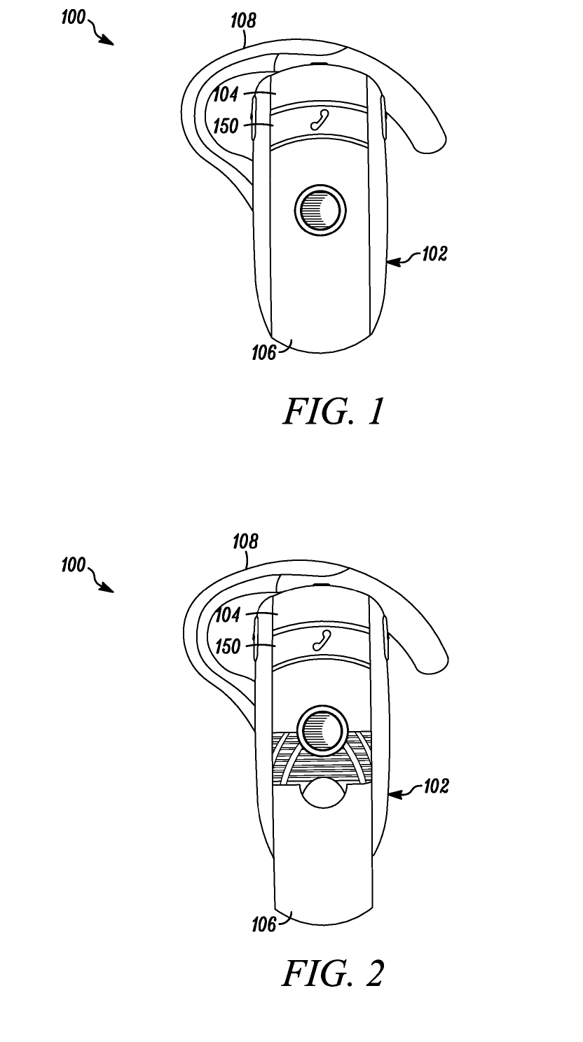

In FIG. 1, a small portable headset 100 includes a housing 102. Housing 102 has a main body, or first housing, 104, and a slider body, or second housing, 106. The slider body 106 is slidingly carried on the main body, such that it slides between a closed position (FIG. 1), with the slider body 106 retracted into the main body 104, and an open position (FIG. 2), with the slider body extended out from the main body. An ear-hook 108 is carried on the housing 102. The ear-hook 108 pivots on the main body and in use hangs over the base of a user's ear to hold the headset on the user's ear. A key 150 is positioned so as to be accessible to the user. Actuation of the key 150 releases the slider body to automatically open by moving away from the main body and turn ON the headset 100 as described in greater detail hereinbelow. FIG. 1 illustrates a closed configuration and FIG. 2 illustrates an open configuration.

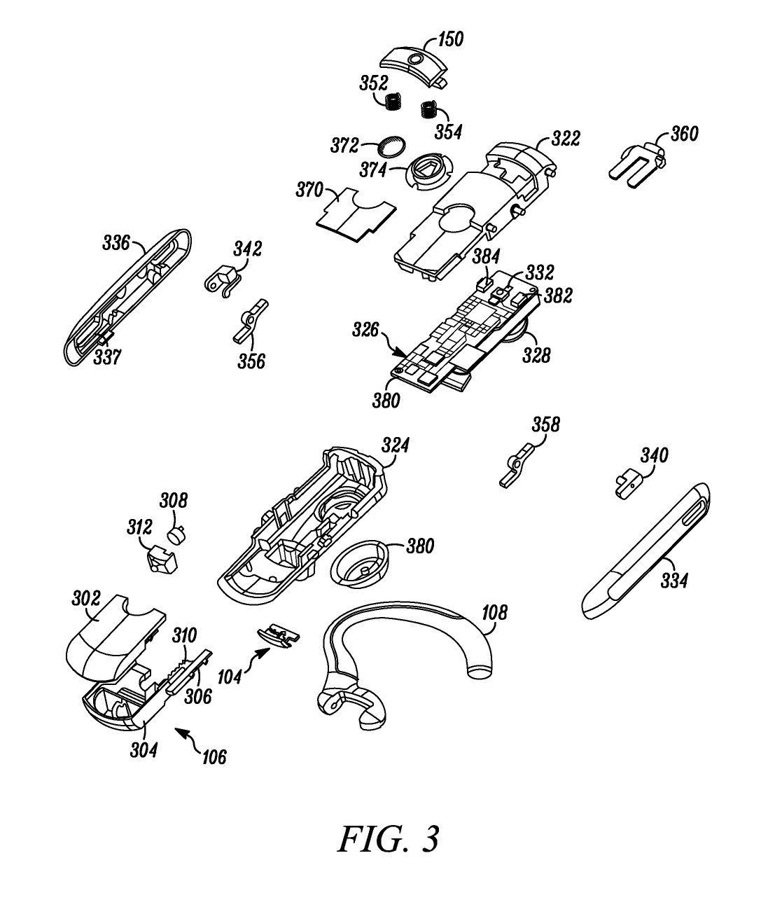

The components of headset 100 are illustrated in exploded view of FIG. 3. The slider body 106 includes a top slider cover 302 and a bottom slider base 304 which are connected to form the slider body. The bottom slider base 304 includes a rail 306 and a rack 310. Another rail (502 in FIG. 5) is located opposite side of the bottom slider base 304. A microphone 308 is carried in a microphone holder 312 such that the microphone faces a microphone opening (512 in FIG. 5) on the distal end of slider body 106.

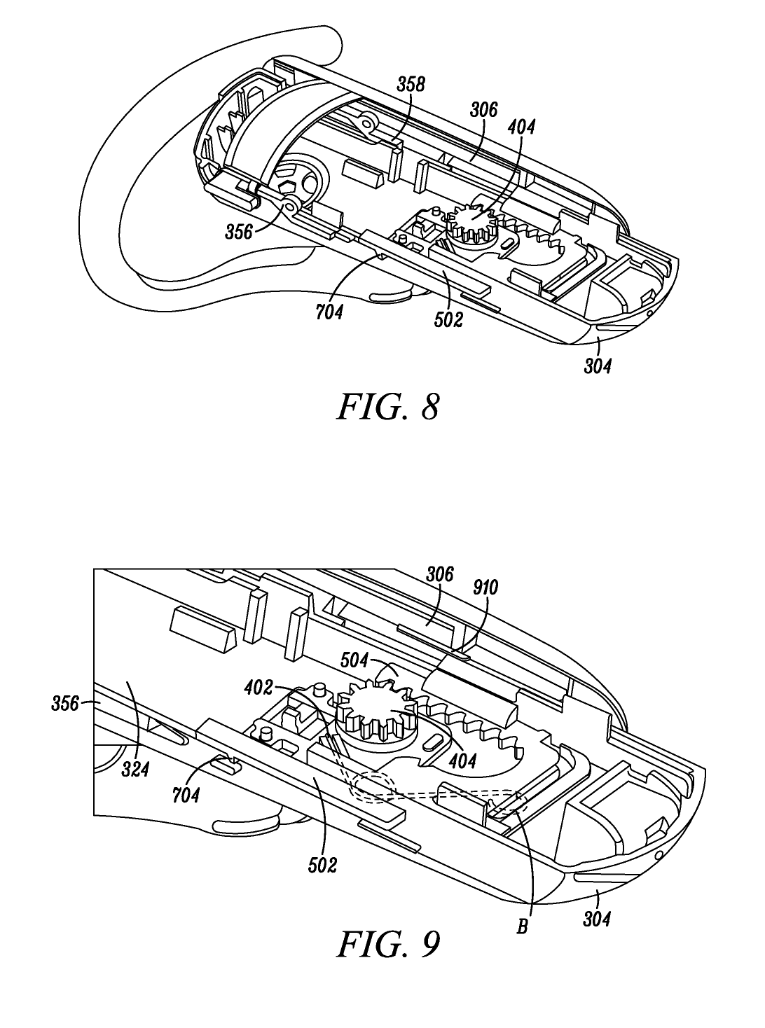

The components of the main body 104 will now described with reference to FIG. 3. The main body 104 includes a top housing member 322 and a bottom housing member 324. A circuit board 326 is positioned between the top and bottom housing members. A first side wall 334 and second side wall 336 are attached to the bottom and top housing members 322, 324. A first side key 340 and a second side key 342 are carried on the first and second side walls 334, 336. The main body 104 also includes an actuator assembly, or key assembly, which includes: a key 150; springs 352, 354; levers 356, 358; and an optional lock switch 360. Decorative elements include a cover 370, disc 372 and disc base 374, attached to an outer surface of top housing member 322. A rubber ear cover 380 provides an acoustic seal for the speaker protrusion on the headset to be inserted in the user's ear (best seen in FIG. 8).

The circuit board 326 can advantageously comprise a printed circuit board 380. A speaker 328 is mounted on a lower surface of the circuit board. A key switch 332 is carried on an upper surface of printed circuit board 380. The key switch is part of the switch assembly, and is actuated in response to movement of the key 150. Switches 382 and 384 are attached to an upper surface of the circuit board and are actuated by keys 340 and 342. Other circuitry attached to the circuit board will not be described for brevity, as these components are commercially available and are not material to an understanding of the invention.

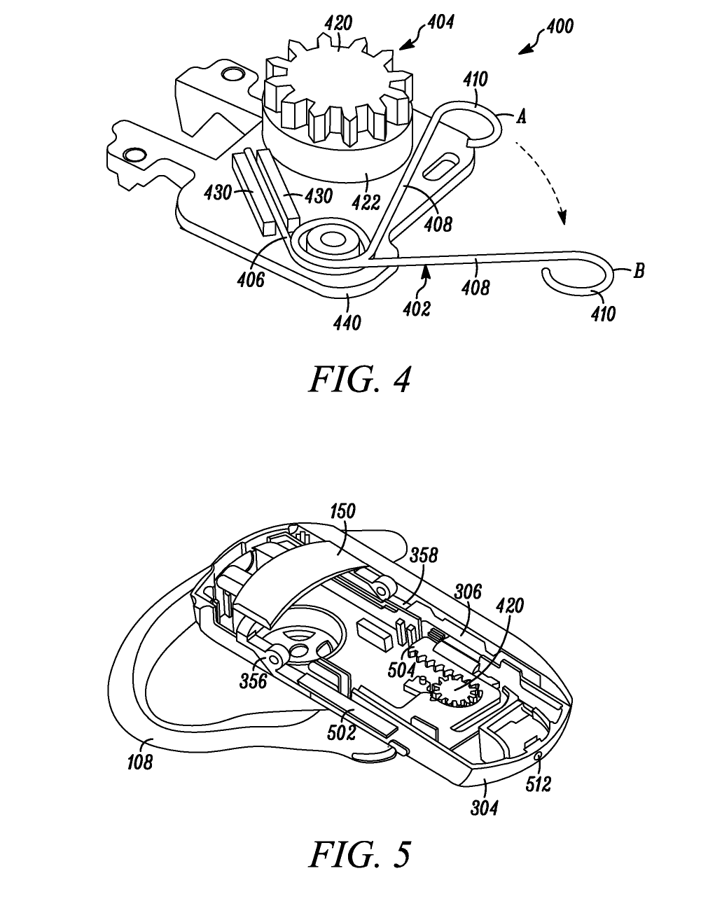

The slider force assembly 400 is illustrated in FIG. 4 as these elements are not visible in the exploded view of FIG. 3. The slider force assembly includes a spring 402 and a damper 404. The illustrated spring 402 is a single coil spring having an anchor arm 406 and a lever arm 408 that moves between position A when it is cocked and position B when it is released. End 410 of arm 408 is curved to assist movement of the spring as it presses against slider body 106. The damper 404 is illustrated as a gear 420 supported in a resistance base 422. The resistance base provides a force that resists the force of spring 402. The damper 404 thus provides smooth friction during rotation of the gear 420, and can be implemented using a viscous fluid, a coil spring, a leaf spring, or the like. Other alternative damper mechanisms include a coil spring, a friction rail, an extension spring, or any other suitable resistance mechanism. The purpose of the damper 404 is to restrain the force created by the spring 402 to thereby provide a smooth and more refined movement. One arm 406 of the spring 402 is anchored in ribs 430 of a mechanism base member 440 which can be integral with the bottom housing member 324 or fixedly attached to the bottom housing member 324.

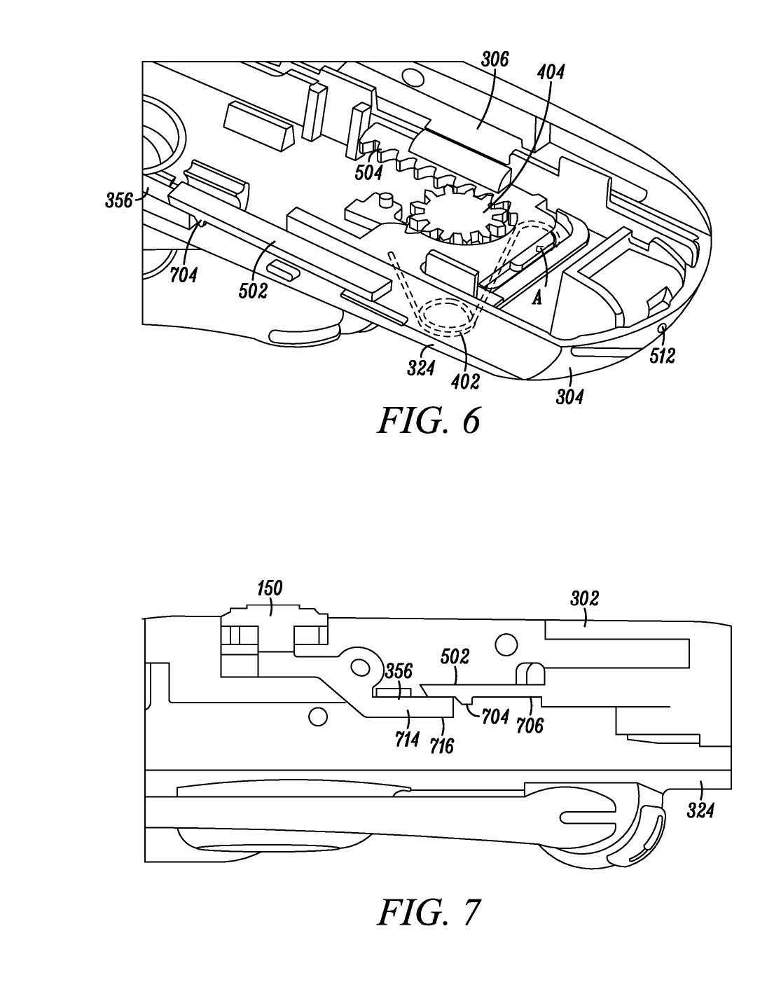

With reference now to FIGS. 5-7, in the closed position, the spring 402 is cocked and arms 502, 306 of the slider housing hold the slider body in the closed position. Tang 704 of arm 502 engages rib 706 to hold the closed position. Lever 356, which pivots on axle 708, is balanced between key 150 and the distal end of arm 702. The arm 714 can rest on a top surface 716 of the bottom housing member 324 in this position. Lever 358 similarly engages arm 306. Springs 352, 354 (FIG. 3) push key 150 upwardly and bias the key in the position illustrated in FIGS. 5-7.

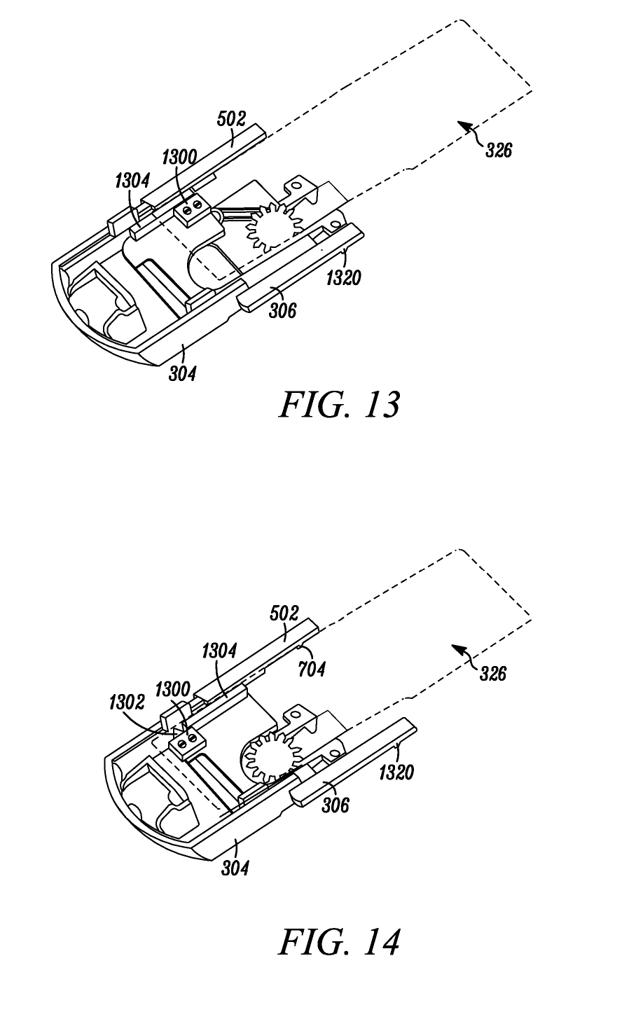

When key 150 is pressed down in FIG. 7, the lever 356 rotates and lifts tang 704 off arm 502 and over the rib 706. Lever 358 rotates at the same time and lifts tang 1320 (FIG. 13) of arm 306. Releasing the tangs 704, 1320 from the ribs 706, (not visible, bit identical to rib 706), initiates an automatic opening under the power of spring 402. The spring 402 pushes the slider body away from the main body, such that arms 306, 502, which provide rails integrally formed in bottom housing member 324, slide in tracks 337 (FIG. 3), 910 (FIG. 9). With reference to FIGS. 8-10, the slider body 106 will stop when the rails on the slider body reach the end of the tracks in the sidewalls. Sidewalls 334, 336 each include a respective track 337, 910 for rails 306, 502. The ends of the rails block further movement of the slider housing, and thus provide a stop for the extension of the slider body as it moves apart from the main body.

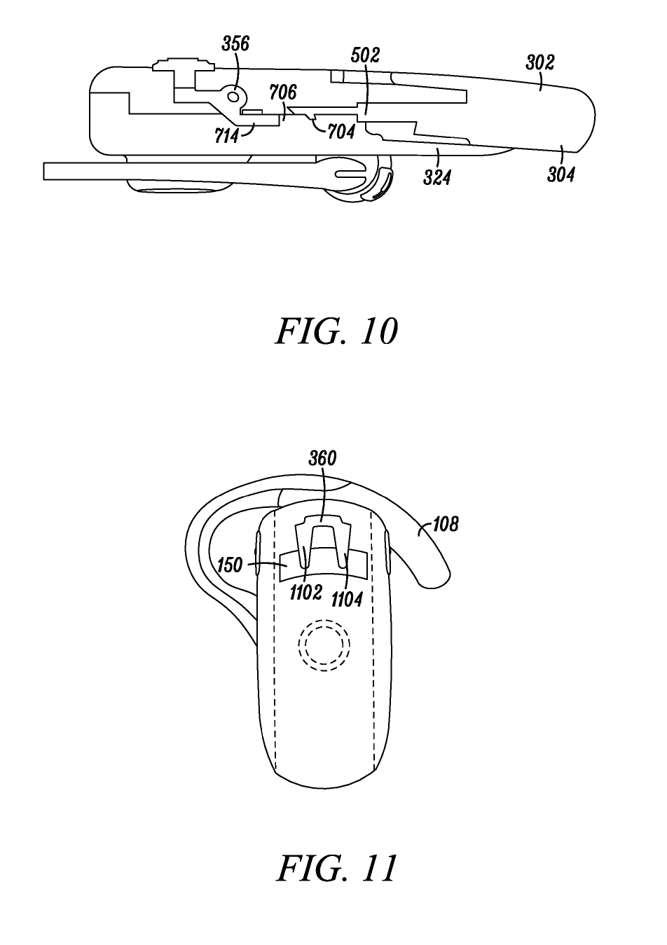

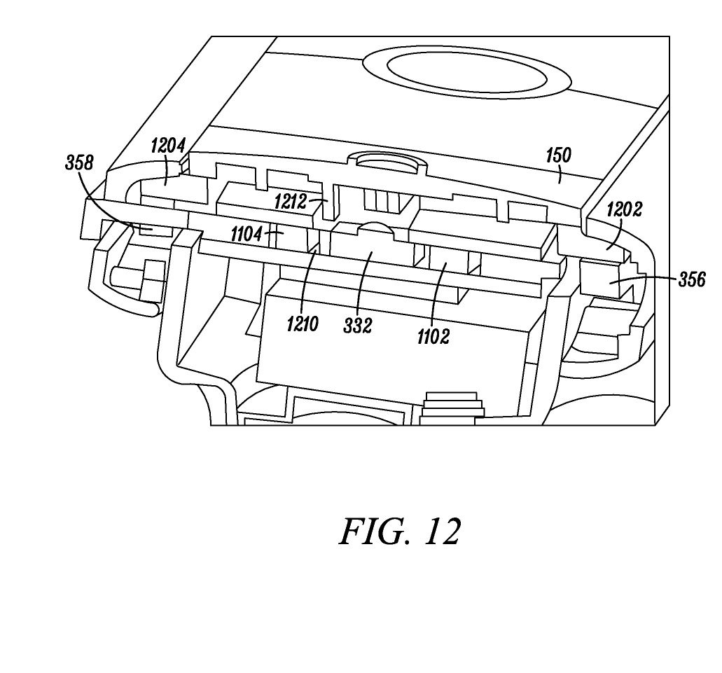

Following depression, the key 150 is returned to the rest position by springs 352, 354. The levers 356, 358 rest against the bottom surface of fingers 1202, 1204 (FIG. 12) on the ends of the key 150. The levers 356, 358 can be biased to the rest position shown in FIGS. 7, 10 by springs (not shown), or movingly attached to the key fingers 1202, 1204. The slider body remains extended under the force of spring 402 until the user returns the slider body to the off position.

As the slider housing moves under the force created by spring 402, the teeth of rack 504 rotate pinion 420. Pinion 420 acts as a damper providing smooth resistance to slow down and improve feel of the automatic open motion.

The headset includes a lock switch 360 (FIG. 11) positioned directly below key 150. Lock switch 360 includes two arms 1102, 1104. Key 150 includes arm 1212 (FIG. 12) aligned with gap 1210. In the unlocked position, shown in FIG. 12, the arm 1212 moves freely into gap 1210 permitting depression of the key. In the locked position, arm 1212 fills the gap 1210 to prevent downward movement of the key 105.

The headset also includes ON/OFF switch 1300 (FIGS. 13 and 14). The ON/OFF switch 1300 is mounted to circuit board 326 such its position is fixed on the main body 104. The actuator 1302 is actuated by the ledge 1304 on bottom housing member 324, the ledge moving when the slider moves. In the open position, illustrated in FIG. 13, the switch is closed by actuator 1302 contacting ledge 1304. In the closed position of FIG. 14, the actuator is released, as the actuator 1302 is spaced from the ledge 1306 in this position.

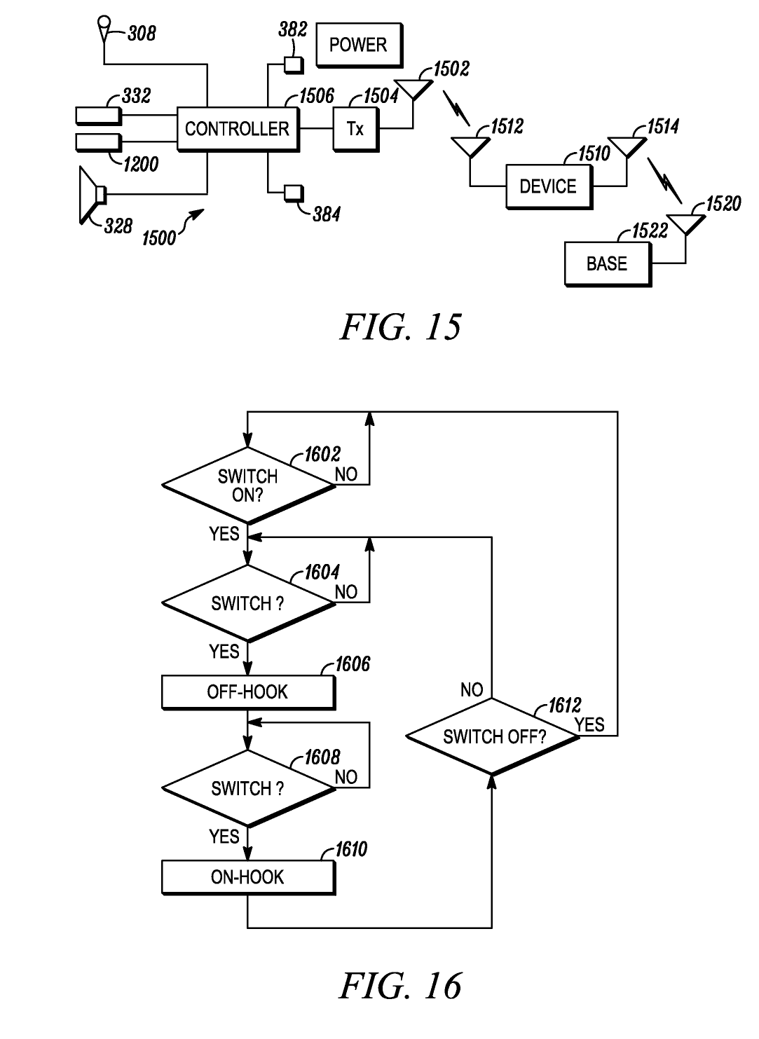

The circuitry 1500 on the circuit board 326 will now be described with reference to FIG. 15. The circuit includes a transceiver 1504. The transceiver 1504 is connected to an antenna 1502 in the illustrated embodiment, representing a wireless communication link. However, the link could be provided by a wire, a light source, or the like, for communicating with another device. The device 1510 may for example be a computer, a radio handset, such as a cordless telephone or a mobile cellular handset, or any other device which can be used with a cordless headset. The transceiver 1504 is also connected to a control circuit 1506. The control circuit 1506 includes a microcontroller, microprocessor, digital signal processor, or the like. It may also include audio circuitry, such as an amplifier, modulator, and demodulator. The microphone 308 and speaker 328 are connected to the controller 1506, which communicates and/or processes the signal and controls the volume responsive to switches 382, 384 actuated by keys 340, 342.

The illustrated device 1510 includes an antenna 1512 for the communication link with headset circuitry 1500. The illustrated device 1510 also includes an antenna 1514 for the communication link with antenna 1522 of base 1520. The device 1510 responds to control signals from headset 100.

In operation, the headset is OFF when the headset is closed, as illustrated in FIG. 1. When the user actuates key 150, the rails 306, 502 are released from holding ribs, and the spring 402 pushes slider body 106 into a position that actuates switch 1200. In this position, the switch turns the headset ON, as indicated in block 1602 (FIG. 16). In the ON position, the controller is responsive to pressing key 150, which actuates switch 332, as detected at block 1604, to generate a change mode signal sent to the device 1510. The user can actuate the button responsive to which the controller 1506 causes the transceiver to transmit a control signal to the device 1510. The device may for example respond to the transmitted control signal to go off-hook (e.g., accept an incoming call from the base or initiate an outgoing connection to the base) for example, where the device 1510 is a telephone, as indicated in block 1606. Subsequent pressing of key 150, resulting in actuation of switch 332, as detected at block 1608, will result in generation of another mode change signal. For example, the user can actuate the button to control the headset to transmit a control signal to device 1510 that causes the device to go on-hook, (end a call or connection with the base) for example, where the device is a telephone, as indicated in block 1610. The user presses the slider body 106 into the main body 104 to move the headset to the closed position. Moving the slide body to the closed position will result in releasing the actuator 1302 of switch 1300, turning the headset OFF. Pressing the headset together to slide the headset to the closed position will thus provide positive indication that that the headset is OFF and cock the spring 402 such that subsequent depression of key 150 will cause the headset to open and turn ON.

While the present disclosure and the best modes thereof have been described in a manner establishing possession and enabling those of ordinary skill to make and use the same, it will be understood and appreciated that there are equivalents to the exemplary embodiments disclosed herein and that modifications and variations may be made thereto without departing from the scope and spirit of the inventions, which are to be limited not by the exemplary embodiments but by the appended claims.

What is claimed is:

1. A small portable headset comprising:
a housing (102) including a first housing member (104) and a second housing member (106), said first housing member slidingly carried on said second housing member;
a spring (402) carried in said housing and biased to push said second housing member away from said first housing member to move said housing to an open position;
a damper (404) carried in said housing to resist movement of the second housing away from said first housing member; and
a key assembly carried in said housing, said key assembly including a key (150), said key actuated to release said first and second housing members to slide apart responsive to the force of said spring.

2. The headset of claim 1, wherein said key assembly includes an electrical switch (332) positioned below said key and actuated by pressing the key.

3. The headset of claim 1, wherein said key assembly includes an electrical switch (332) positioned below said key and actuated by pressing the key when said housing is in an open position and an electrical circuit (1500) responsive to actuation of said switch when the housing is in the open position to transmit a mode change signal.

4. A portable headset comprising:
a housing having first and second housing members;
a key carried on said housing, said key actuated to release one of the first and second housing members to slide from the other of said first and second housing members, to configure said housing in an open position, said portable headset ON in said open position;
a switch positioned below said key, the switch actuated to transmit a control signal; and
a circuitry responsive to actuation of the switch while said housing is in said open position to generate a mode change signal.

5. The headset according to claim 4, wherein including an ON/OFF switch actuated by the second housing member, whereby sliding movement of said second housing member response to depression of said initiates automatic open which to turns the headset ON, and sliding the second housing into the closed position turns the headset OFF.

6. A portable headset, comprising:
a housing including a main body and a slide body, the slide body moving between an open position and a closed position;
a release carried in said housing, the release including a key which is actuated when said housing is closed to release the slide body to automatically slide out from the main body;
an ON/OFF switch carried in said housing and positioned to be actuated by said slide body;
a key switch carried in said housing and actuated by the said key; and
a controller response to the ON/OFF switch to turn the headset ON in the open position and turn the headset OFF in the closed position, and responsive to the key switch to transmit a control signal to a communication device with which the headset is being used responsive to actuation of the key while the headset is in the open position.
